(19) United States
(12) Patent Application Publication
(10) Pub. No.: US 2012/0001723 A1
(43) Pub. Date: Jan. 5, 2012

(54) Display of Devices on an Interface based on a Contextual Event

(75) Inventor: Jim Hunter, Sunnyvale, CA (US)

(73) Assignee: MOTOROLA MOBILITY, INC., Libertyville, IL (US)

(21) Appl. No.: 13/228,113

(22) Filed: Sep. 8, 2011

Related U.S. Application Data
(63) Continuation of application No. 12/708,173, filed on Feb. 18, 2010.
(60) Provisional application No. 61/153,836, filed on Feb. 19, 2009.

(51) Int. Cl. G05B 19/02

(52) U.S. Cl. 340/4.31

(57) ABSTRACT

In one embodiment, a method includes displaying a portion of a plurality of devices in a viewing area on an interface. The portion of the plurality of devices are controllable automatically through the interface. A selection of a device in the portion of the plurality of devices is received. A first set of devices in the plurality of devices is determined that includes a similar controllable feature as the selected device. A second set of devices in the portion of the plurality of devices that does not include the similar controllable feature is also determined. The method then replaces the second set of devices with the first set of devices in the viewing area. The similar controllable feature for the selected device and the first set of devices is controllable through the interface.

### CROSS REFERENCE TO RELATED APPLICATIONS

The present application claims priority to U.S. Provisional App. No. 61/382,071 for “Selecting an Associated Set of Devices from a Collection” filed Sep. 13, 2010, the contents of which is incorporated herein by reference in their entirety.

### BACKGROUND

A user may control different devices automatically using a user interface. For example, televisions, lights, thermostats, and other electronic devices may be controlled in a household. The devices may be associated with different manufacturers or communicate using different protocols. A different user interface may need to be used for different groups of devices based on the devices' compatibility with a manufacturer and/or protocol. For example, a first user interface is used to control devices associated with a first manufacturer and a second interface is used to control a group of devices associated with a second manufacturer. Additionally, different user interfaces may need to be used if the devices communicate using different protocols. Thus, even if devices are manufactured by the same manufacturer, the same user interface may not be used to control both devices if the devices communicate using a different protocol.

Also, when controlling devices using a user interface, a user may be allowed to access one of the devices at a time. Thus, if a user wants to perform multiple actions to control multiple devices, each device is selected in a serial fashion and the action is applied. For example, a user may want to turn a light off and set the thermostat to a certain temperature. The user would select the light and turn the light off. Then, the user would select the thermostat and set the thermostat to a desired temperature.

In another situation, the user interface may have limited screen space and cannot display all of the devices at once. The user may scroll through the interface to determine which devices to control. Scrolling through a long list of devices may be inconvenient and time consuming. Also, when the user scrolls to a screen with a number of devices that that user wants to control, in one example, the user may control multiple devices that are being displayed on the user interface with one command However, the user is limited to the devices that are currently being displayed and if a device is off-screen that user also wants to control, the user cannot control that device without scrolling to the screen the device is on.

### SUMMARY

In one embodiment, a method includes displaying a portion of a plurality of devices in a viewing area on an interface. The portion of the plurality of devices are controllable automatically through the interface. A selection of a device in the portion of the plurality of devices is received. A first set of devices in the plurality of devices is determined that includes a similar controllable feature as the selected device. A second set of devices in the portion of the plurality of devices that does not include the similar controllable feature is also determined. The method then replaces the second set of devices with the first set of devices in the viewing area. The similar controllable feature for the selected device and the first set of devices is controllable through the interface.

In one embodiment, a non-transitory computer-readable storage medium contains instructions for controlling a computer system to be operable to: display a portion of a plurality of devices in a viewing area on an interface, the portion of the plurality of devices being controllable automatically through the interface; receive a selection of a device in the portion of the plurality of devices; determine a first set of devices in the plurality of devices that includes a similar controllable feature as the selected device; determine a second set of devices in the portion of the plurality of devices that does not include the similar controllable feature; and replace the second set of devices with the first set of devices in the viewing area, wherein the similar controllable feature for the selected device and the first set of devices is controllable through the interface.

In one embodiment, an apparatus includes one or more computer processors; and a computer-readable storage medium comprising instructions. The instructions are for controlling the one or more computer processors to be operable to: display a portion of a plurality of devices in a viewing area on an interface, the portion of the plurality of devices being controllable automatically through the interface; receive a selection of a device in the portion of the plurality of devices; determine a first set of devices in the plurality of devices that includes a similar controllable feature as the selected device; determine a second set of devices in the portion of the plurality of devices that does not include the similar controllable feature; and replace the second set of devices with the first set of devices in the viewing area, wherein the similar controllable feature for the selected device and the first set of devices is controllable through the interface.

The following detailed description and accompanying drawings provide a more detailed understanding of the nature and advantages of the present invention.

### BRIEF DESCRIPTION OF THE DRAWINGS

FIG. 1 depicts an example of a computing device that is used to control devices according to one embodiment.

FIG. 2 depicts an example of a user interface after a selection is received according to one embodiment.

FIG. 3 shows a more detailed example of the user interface according to one embodiment.

FIG. 4 shows a second set of devices in a viewing area when the user interface is scrolled according to one embodiment.

FIG. 5 shows an example of the user interface after a device has been selected in the viewing area according to one embodiment.

FIG. 6 shows an example of rearranging devices after receiving a subsequent selection according to one embodiment.

FIG. 7 depicts an example of the user interface after scrolling is performed according to one embodiment.

FIG. 8 shows an example of the user interface for controlling devices according to one embodiment.

FIG. 9 shows a more detailed example of the user interface showing the ability to control devices according to one embodiment.

FIG. 10 shows an example where a device has been selected in the viewing area according to one embodiment.

FIG. 11 shows an example of the user interface showing multiple controls according to one embodiment.

FIG. 12 shows an example of the user interface when multiple devices have been selected according to one embodiment.

FIG. 13 depicts a simplified flowchart of a method for displaying devices on the user interface according to one embodiment.

FIG. 14 shows a more detailed example of the computing device according to one embodiment.

FIG. 15 depicts a simplified system according to one embodiment.

### DETAILED DESCRIPTION

Described herein are techniques for a device control interface. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

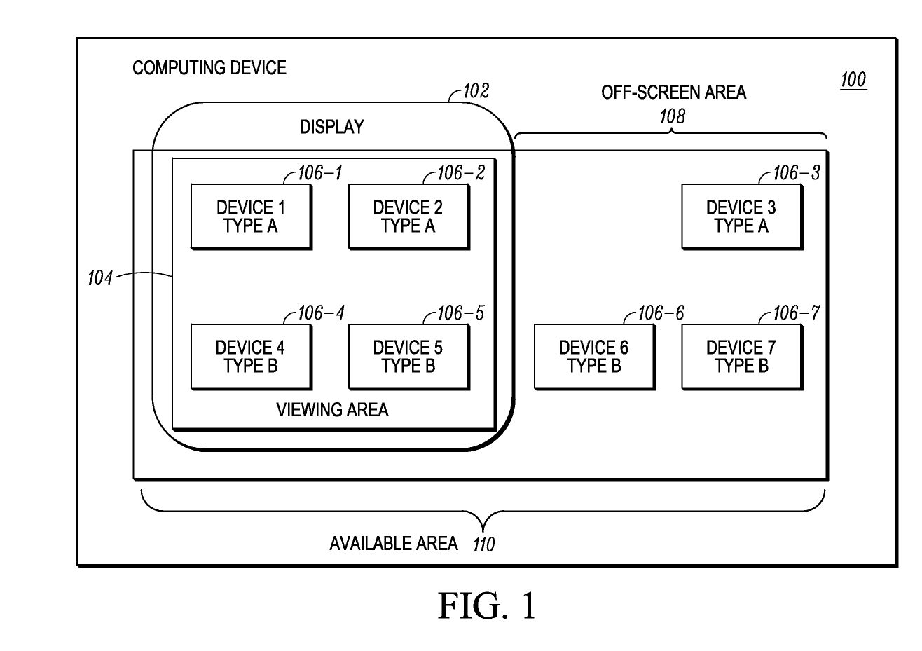

FIG. 1 depicts an example of a computing device 100 that is used to control devices according to one embodiment. An available area 110 shows devices 106 that are available for control and access. A graphical user interface 102 includes a viewing area 104 and an off-screen area 108. Viewing area 104 is an area that is used to display information to the user and information in off-screen area 108 is not displayed to the user, but the user can adjust (e.g., scroll, page, etc.) the display of user interface 102 to display information from off-screen area 108. In one example, devices 106 that are available cannot be displayed all at once in viewing area 104. As shown, devices 106-1, 106-2, 106-4, and 106-5 are displayed in viewing area 104 and devices 106-3, 106-6, and 106-7 are displayed in off-screen area 108. When the term “device” is used, device may mean an icon, name, or other display notation that is used to represent a physical or virtual device that can be controlled. For example, devices 106 include items that may be found in a location, such as a home, business, or other area. Devices 106 include physical devices, such as lights, televisions, appliances, and thermostats, and virtual devices, such as applications, content, music, and content feeds.

Devices 106 may be associated with properties, which may describe the controllable features for devices 106. A controllable feature may be any capability of a device 106 that can be controlled automatically. For example, a light may have a controllable feature that allows the light to be turned on and off. Thermostats include controllable features that allow the temperature to be increased, decreased, and set at a specified temperature.

Devices 106 may be classified by controllable features. The classification may be by a type or by a minimum set of controllable features. For example, the type may classify a group of devices 106 that operate similarly, such as a light type or a thermostat type. The same type of devices 106 include a set of similar controllable features. Also, different types of devices may be classified by minimum set of controllable features. For example, a light and a television may include an on/off controllable feature and can be classified by the on/off controllable feature.

Particular embodiments provide clustering of devices 106 when a selection of a device 106 in viewing area 104 is performed. For example, properties of available devices 106 are analyzed to determine if the ordering of devices in available area 110 should be rearranged to display different devices 106 in viewing area 104. Particular embodiments rearrange the order to allow for easier access of devices 106. For example, devices 106 of the same type that include a similar controllable feature as a selected device 106 may be displayed. Devices 106 in off-screen area 108 may replace devices 106 in viewing area 104 while minimizing position changes. For example, newly displayed devices 106 are placed in same positions as replaced devices 106 and devices 106 that are not replaced remain in a same position. Also, the control of devices 106 in viewing area 104 is simplified because devices displayed in viewing area 104 may include similar controllable features that can be controlled together using interface 102.

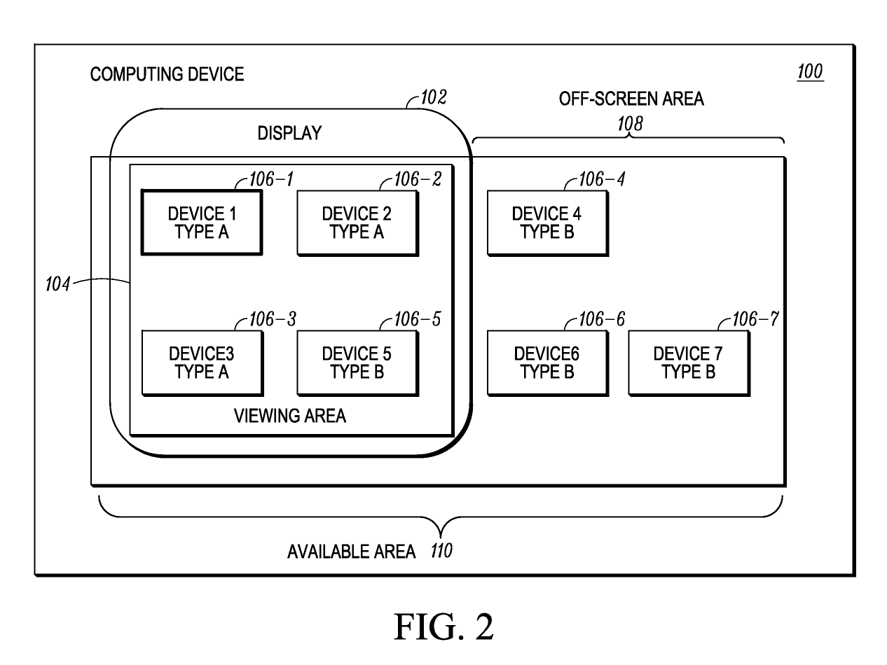

In FIG. 1, devices 106 of a type A and a type B are available. Currently, viewing area 104 shows devices of a type A and a type B. A selection of one of the devices 106 may then be received. FIG. 2 depicts an example of user interface 102 after a selection is received according to one embodiment. As shown, device 106-1 has been selected and is marked by bold highlighting. Devices 106 in available area 110 have been rearranged based on the selection.

Device 106-1 is of a type A. Based on the selection, devices 106 of type A are moved into viewing area 104 from off-screen area 108. For example, device 106-3 has been displayed in viewing area 104 in place of device 106-4. Devices 106-1, 106-2, and 106-5 remain in the same positions. Device 106-3 has been moved to viewing area 104 because it is of the same type (e.g., type A) as selected device 106-1. In this case, all devices 106 of the same type are displayed in viewing area 104. Device 106-5 is of a different type (e.g., type B), but another device of type A is available to replace device 106-5. Thus, device 106-5 is not moved to another position.

In one embodiment, the selected device 106-1 is not moved positions in the rearrangement. For example, if device 106-1 was in the upper left position before the selection, device 106-1 remains in the upper left position after the selection. Also, a device 106 is placed in a position of a device 106 being replaced and other devices 106 that are not replaced are not moved. This minimizes the position changes in viewing area 104, which may be convenient for a user who is used to viewing the devices 106 in certain positions before the selection.

The determination of which devices 106 to move may be based on devices 106 having similar controllable features. For example, the determination is based on the type of devices 106 where each type has a similar controllable feature. The type may describe device 106, such as a “light” or a “thermostat.” Also, the determination may be made based on a minimum set of controllable features for the selected device 106. The minimum set of controllable features is used to match other devices 106 that include the minimum set of controllable features.

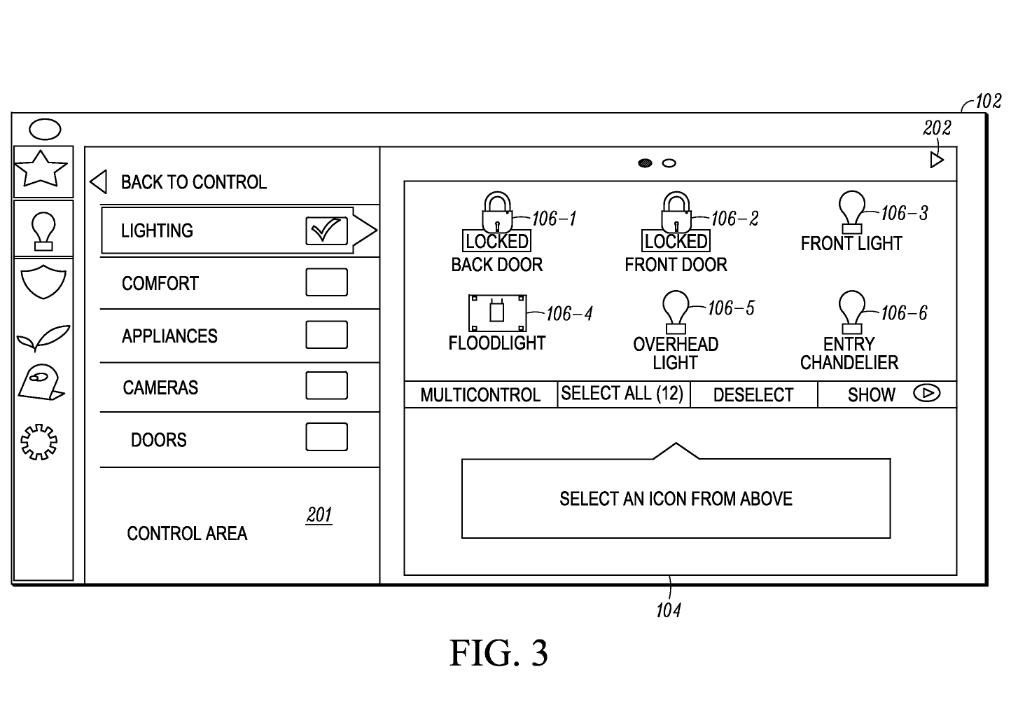

FIG. 3 shows a more detailed example of interface 102 according to one embodiment. Viewing area 104 includes devices 106 of different types. For example, devices 106-1 and 106-2 are door locks; devices 106-3, 106-5, and 106-6 are lights; and device 106-4 is a light switch. Additionally, a control area 201 shows different categories of devices 106 that can be controlled. A user can select a category to include devices 106 in available area 110. For example, the categories include lights, comfort, appliances, cameras, and doors.

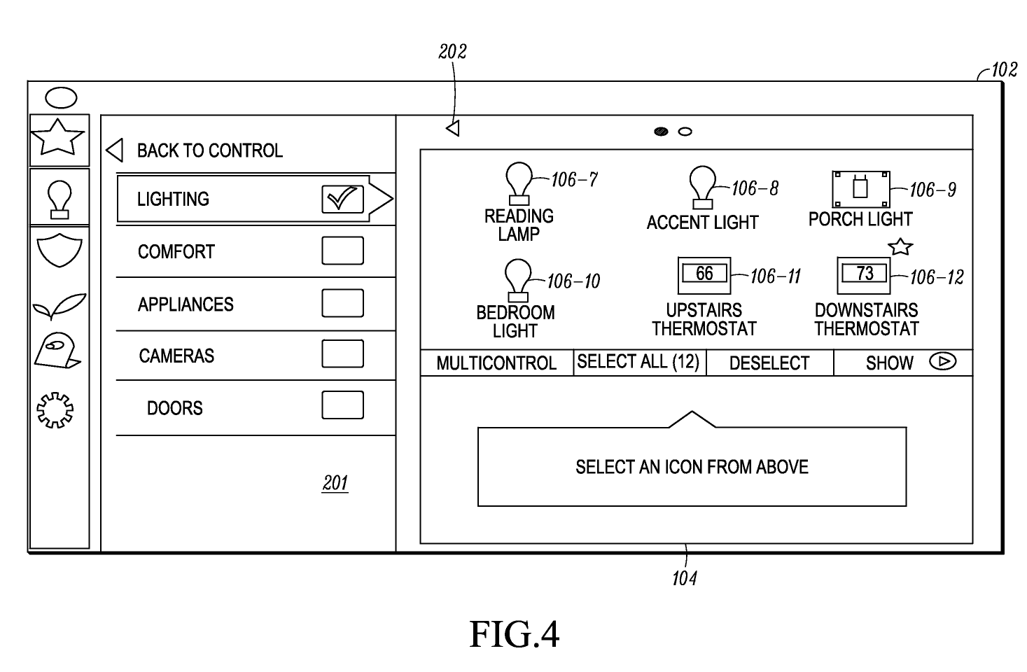

The available devices in available area 110 are shown on two pages. The user can scroll to the right using an arrow 202 to page through available devices 106. Other methods, such as “scraping” and key strokes, may be used. FIG. 4 shows a second set of devices that were in off-screen area 108, but are now displayed in viewing area 104 when user interface 102 is scrolled to the right. As shown, devices 106-7, 106-8, and 106-10 are lights; device 106-9 is a light switch; and devices 106-11 and 106-12 are thermostats.

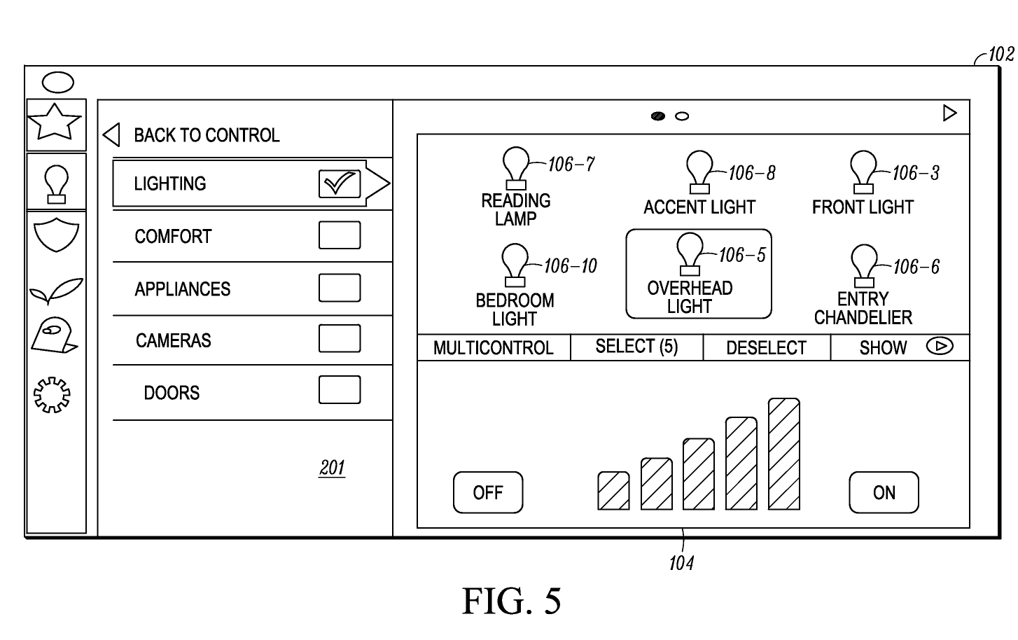

FIG. 5 shows an example of interface 102 after a device 106 has been selected in viewing area 104 according to one embodiment. As shown, device 106-5 has been selected and is an overhead light. Devices of the same type (e.g., lights) have been moved to be displayed in viewing area 104. For example, device 106-7 (a reading lamp) has replaced device 106-1 (a back door lock); device 106-8 (accent lights) has replaced device 106-2 (a front door lock); and device 106-10 (a bedroom light) has replaced device 106-4 (a floodlight switch). Thus, all devices 106 that are displayed in viewing area 104 are associated with the same type of device (e.g., lights). Also, device 106-5 has not been moved to another position. Rather, new devices 106 remain in the same position as the replaced device 106. Device 106-3 (a front light) and device 106-6 (an entry chandelier) remain in the same positions because they are of the same type as device 106-5.

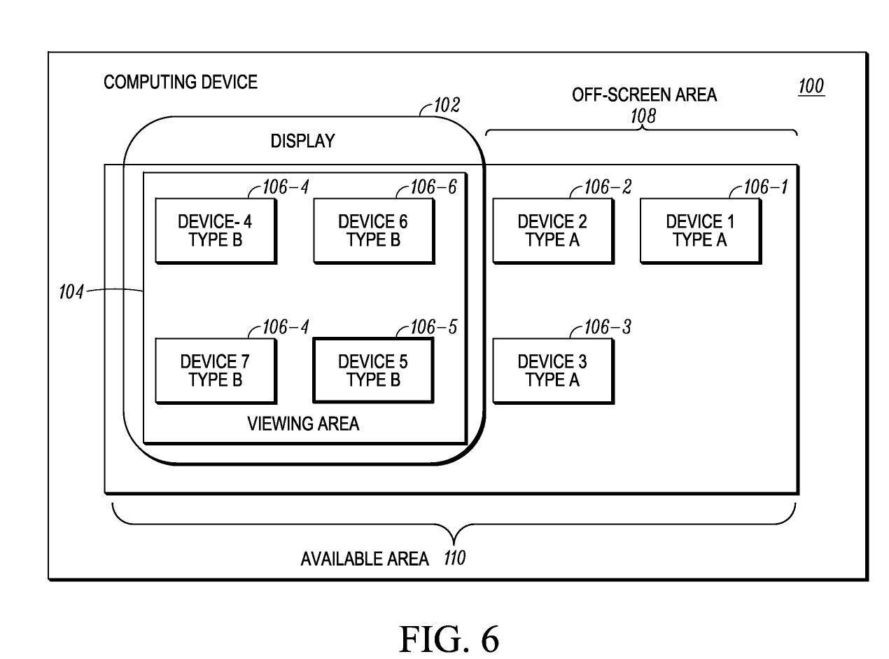

Another selection may be made by a user and viewing area 104 is rearranged again. FIG. 6 shows an example of rearranging devices 106 after receiving a subsequent selection according to one embodiment. As shown, device 106-5 has been selected. Devices 106-1, 106-2, and 106-3 have been removed from viewing area 104. In those devices' positions, devices 106-4, 106-6, and 106-7 have been inserted, respectively. Devices 106-4, 106-6, and 106-7 are all of a type B. Thus, the user may now control devices of type B using interface 102.

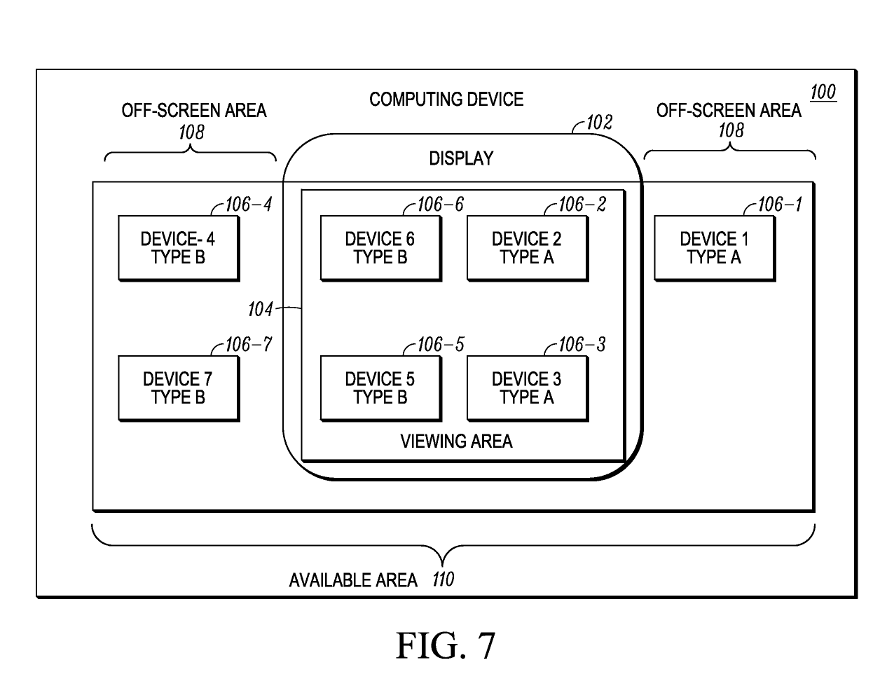

If the user desires to view other devices 106, the display may be scrolled. FIG. 7 depicts an example of interface 102 after scrolling is performed according to one embodiment. For example, viewing area 104 may be scrolled to the right or the left. In the example shown, viewing area 104 has been scrolled to the right. Now, devices 106-6, 106-2, 106-5, and 106-3 are shown. These devices are of mixed types. The user may then select one of these devices and have devices of a similar type displayed in viewing area 104 again.

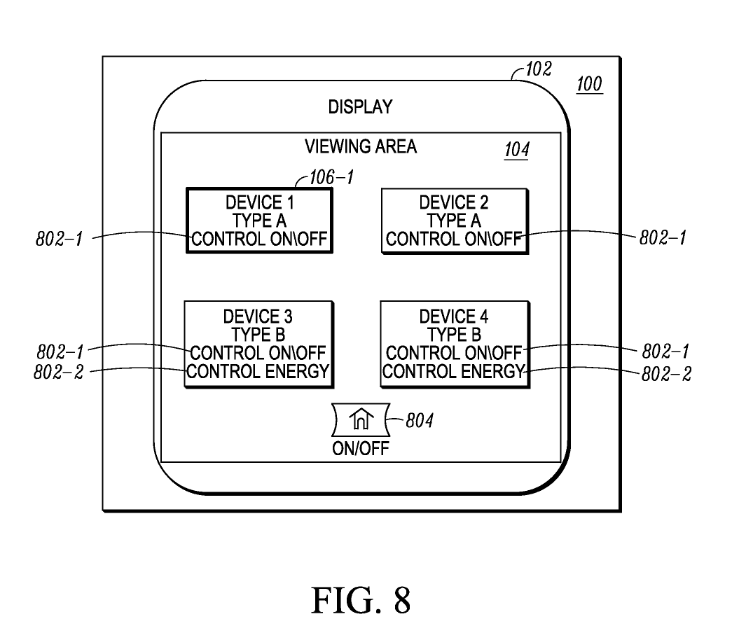

Control of devices 106 in viewing area 104 can also be performed using interface 102. In one example, all devices 106 shown in viewing area 104 may be controlled together. Thus, only devices 106 that have a similar control may be displayed in viewing area 104. In other embodiments, devices 106 that may not be able to be controlled together may be displayed in viewing area 104, but any control is not applied to those devices 106. FIG. 8 shows an example of interface 102 for controlling devices 106 according to one embodiment. As shown, device 106-1 has been selected. Device 106-1 is of a type A and includes a controllable feature 802-1 that allows device 106-1 to be turned on and off. Device 106-2 is of the same type as device 106-1 and also includes the same controllable feature 802-1. Devices 106-3 and 106-4 are of a type B and also include controllable feature 802-1. Additionally, devices 106-3 and 106-4 include a controllable feature 802-2 that allows the energy used by devices 106-3 and 106-4 to be controlled. The energy may include the amount of power used, such as energy control to dim lights.

A control 804 is displayed to allow devices 106 in viewing area 104 to be controlled. For example, devices 106-1-106-4 may be turned on and off Control 804 allows controlling of similar controllable features 802 for all devices 106 displayed in viewing area 104. For example, control 804 allows a user to control controllable feature 802-1. A control 804 for controllable feature 802-2 is not displayed because it cannot be used to control all devices 106 in viewing area 104. Although the control 804 is described as being for a controllable feature 802 included in all devices displayed in viewing area 104, devices 106 may be displayed in viewing area 104 that do not include a controllable feature 802 being controlled. Certain indications, such as different shading, may indicate that these devices 106 may not be controlled.

When control 804 is selected, then, the control is applied to the applicable devices 106. In the example shown in FIG. 8, devices of a type A and type B are turned on or off. In one embodiment, if all devices 106 of the same type in available area 110 cannot all be displayed in viewing area 104, the control may still be applied to devices 106 in off-screen area 108. User preferences may set whether devices 106 in off-screen area 108 should be controlled.

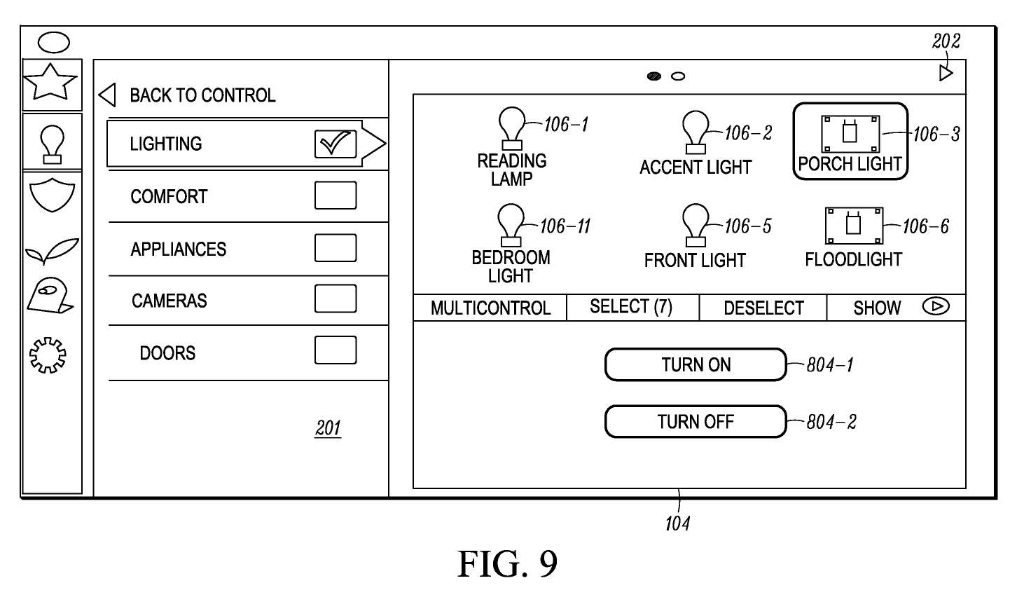

FIG. 9 shows a more detailed example of interface 102 showing the ability to control devices 106 according to one embodiment. As shown, a porch light switch 106-3 has been selected. Device 106-6 is of the same type (e.g., flood light switch). However, devices 106-1, 106-2, 106-4, and 106-5 are of a different type (e.g., lights). However, all devices 106 shown in viewing area 104 can be controlled by a similar controllable feature 802 of on/off. Controls 804-1 and 804-2 are provided to control devices 106-1-106-6. Control 804-1 allows the user to turn on all devices 106 in viewing area 104 and control 804-2 allows the user to turn off all devices 106 shown in viewing area 104.

In one embodiment, a minimum set of matching controllable features 802 is used to determine which devices to display. For example, at least one controllable feature 802 may need to be similar between devices 106 shown in viewing area 104. However, devices 106 in viewing area 104 may include additional controllable features as long as the minimum set of controllable features 802 is similar. Devices 106 that do not include the minimum set of controllable features 802 as the selected device 106 may be removed from viewing area 104.

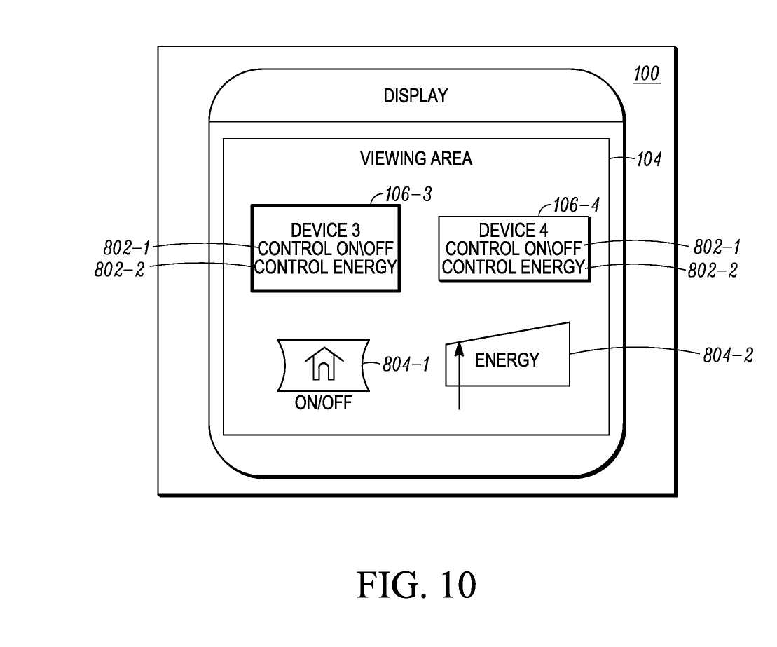

FIG. 10 shows an example where a device 106-3 has been selected in viewing area 104 according to one embodiment. Device 106-3 includes the controllable features 802-1 and 802-2. In one example, a minimum set of controllable features 802 includes both controllable features 802-1 and 802-2. Thus, only devices 106 that include both controllable features 802-1 and 802-2 are displayed in viewing area 104. In this case, devices 106-1 and 106-2 previously shown in viewing area 104 in FIG. 8 do not include the minimum set of matching controllable features 802. That is, devices 106-1 and 106-2 include controllable feature 802-1, but do not include controllable feature 802-2. Thus, devices 106-1 and 106-2 are removed from viewing area 104. However, devices 106-3 and 106-4 include both controllable features 802-1 and 802-2. In other embodiments, the minimum set does not need to include all controllable features 802 included in a selected device 106. Rather, only one controllable feature 802 (or a number less than the full set of controllable features 802) may be included in the minimum set.

An on/off control 804-1 and an energy control 804-2 are shown in interface 102. This allows devices 106-3 and 106-4 to be controlled together. For example, the user may turn devices 106-3 and 106-4 on and off together or may raise or lower the amount of energy (e.g., dim the lights in one example).

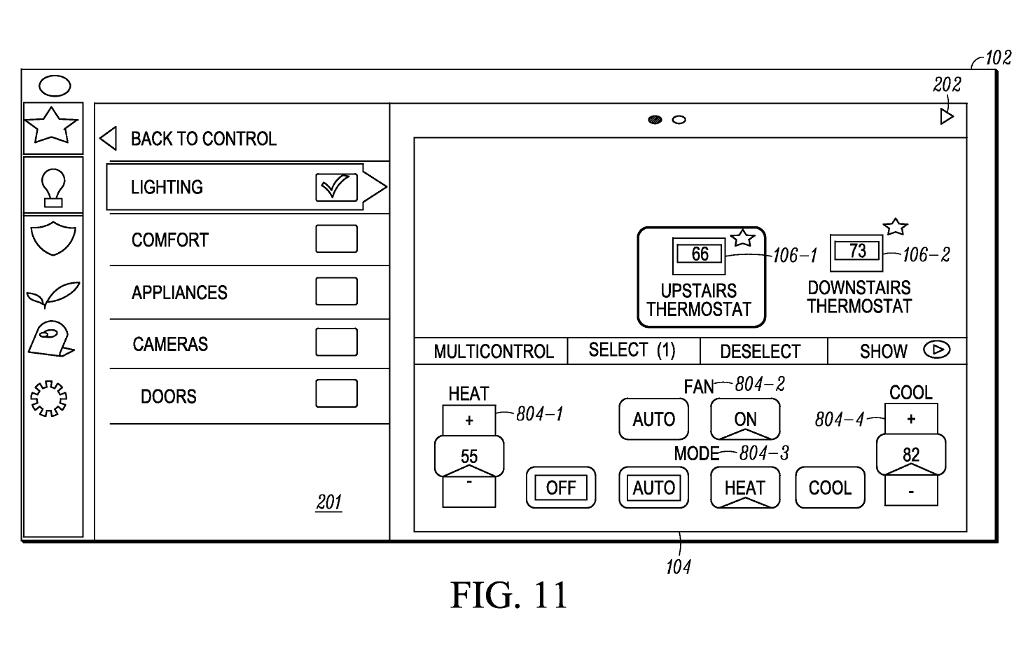

FIG. 11 shows an example of interface 102 showing multiple controls 804 according to one embodiment. Device 106-1 has been selected and is a thermostat. A control 804-1 may be used to control the heat; a control 804-2 may be used to control the fan; a control 804-3 may be used to control the mode, and a control 804-4 may be used to control the air conditioning (e.g., cool). These controls apply only for device 106-1.

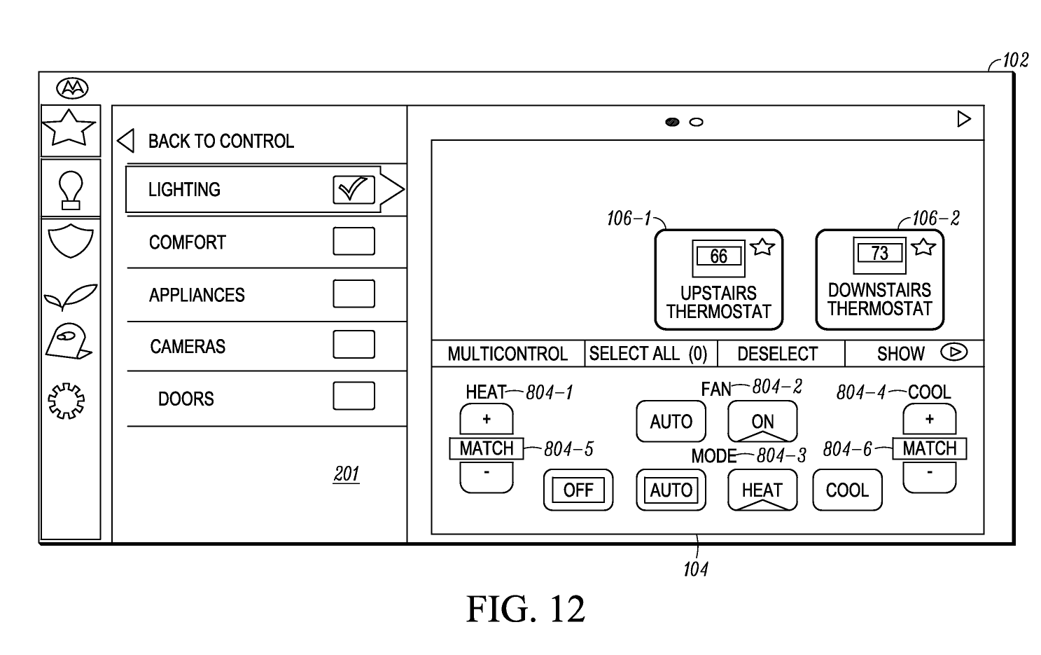

FIG. 12 shows an example of interface 102 when multiple devices have been selected according to one embodiment. Devices 106-1 and 106-2 have been selected. Both devices are thermostats; however, they are set at different temperature levels. For example, the upstairs thermostat is set at a temperature of 66° F. and the downstairs thermostat is set at 73° F. Controls 804 may be provided to allow for the controlling of both thermostats. For example, control 804-5 and control 804-6 may be used to control both thermostats by providing a match control of the temperatures for both thermostats. Previously, in FIG. 11, controls 804-1 and 808-4 were used to control the exact temperatures for individual thermostats. Because both thermostats are being controlled together, a control 804 is provided to allow both thermostats to be controlled together. If control 804-5 is selected, then the heat setting for both thermostats may be matched. In this case, both thermostats may be set to 73° F. If control 804-6 is selected, then the air conditioning setting for both thermostats may be matched. In this case, both thermostats may be set to 66° F. Other controls 804-2 and 804-3 apply to both thermostats and may be used to control features of both. For example, both thermostats may be controlled to turn the fans on/off.

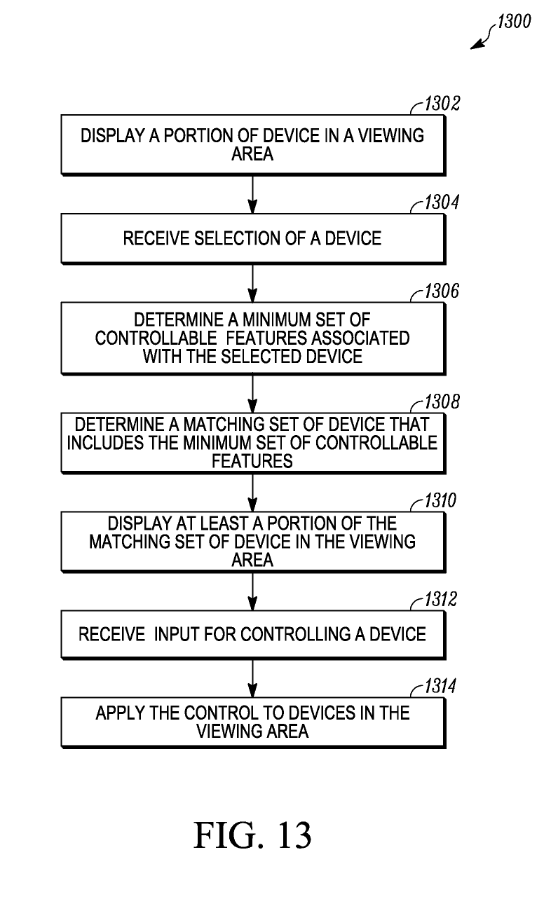

FIG. 13 depicts a simplified flowchart of a method for displaying devices 106 on interface 102 according to one embodiment. At 1302, a portion of devices 106 are displayed in viewing area 104. Devices 106 may be controlled automatically through interface 102.

At 1304, a selection of a device 106 is received. At 1306, a minimum set of controllable features 804 associated with selected device 106 is determined The minimum set of controllable features 804 may be determined based on a type of device 106 or the number of controllable features 804 included in the selected device 106. At 1308, a matching set of devices 106 that includes the minimum set of controllable features 804 is determined The matching set may be determined based on a one to one match of controllable features 804. Other algorithms may be used to compare similarity of controllable features 804 for devices 106 to the controllable features 804 in the minimum set. For example, a volume control of a television and an energy control of a light may be considered similar in some cases, but may not be an exact match of a controllable feature.

At 1310, at least a portion of the matching set of devices is displayed in viewing area 104. For example, if the number of devices 106 in the matching set of devices 106 can be displayed in viewing area 104, then all of devices 106 are displayed. If the matching set of devices 106 includes more devices 106 that can be displayed in viewing area 104, then some devices 106 may be displayed in off-screen area 108. Also, the number of devices 106 that can be displayed on user interface 102 may be changed (e.g., from 6 to 10) to accommodate displaying all of devices 106. At 1312, an input for controlling a device 106 in viewing area 104 is received. At 1314, the control is applied to devices 106 in viewing area 104 in the matching set. In one embodiment, when devices 106 displayed in viewing area 104 are controlled, devices 106 that are off-screen in the matching set may also be controlled automatically.

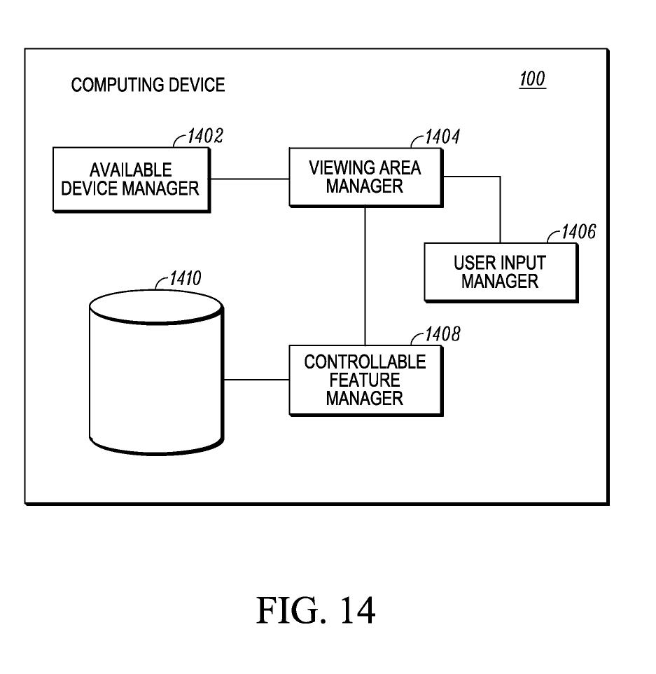

FIG. 14 shows a more detailed example of computing device 100 according to one embodiment. The logic included in computing device 100 may be part of the computing device displaying interface 102 or may be distributed in a computing device located remotely from interface 102. For example, the logic may be located in a control point used to control devices 106, which is described in more detail below, or a web server.

An available device manager 1402 is used to determine the available devices 106 for control. For example, users may select different sets of devices to display in interface 102. Examples include lighting, appliances, cameras, doors, etc.

Viewing area manager 1404 determines devices 106 from the available devices 106 to display in viewing area 104. Depending on user inputs received from a user input manager 1406, viewing area manager 1404 may change devices 106 that are displayed in viewing area 104. The changes may be performed as described above.

A controllable feature manager 1408 is used to determine controllable features 802 for devices 106 in viewing area 104. A database 1410 may store information for controllable features 802 for devices 106. Viewing area manager 1404 may use controllable features 802 to determine which devices 106 to display in viewing area 104. User input manager 1406 receives user input selecting a device 106 and viewing area manager 1404 determines which devices 106 to display in viewing area 104 based on the user input and controllable features 802 for devices 106. Additionally, controllable feature manager 1408 may control devices 106 when the user input is for a control 804 of device 106. For example, the control is applied to devices 106 through the control point.

Accordingly, the clustering of devices 106 in viewing area 104 allows devices 106 to be rearranged to display devices 106 a user may desire to control together. This makes it easier for a user to control devices 106. Further, controls 804 are determined to allow a user to control devices 106 together.

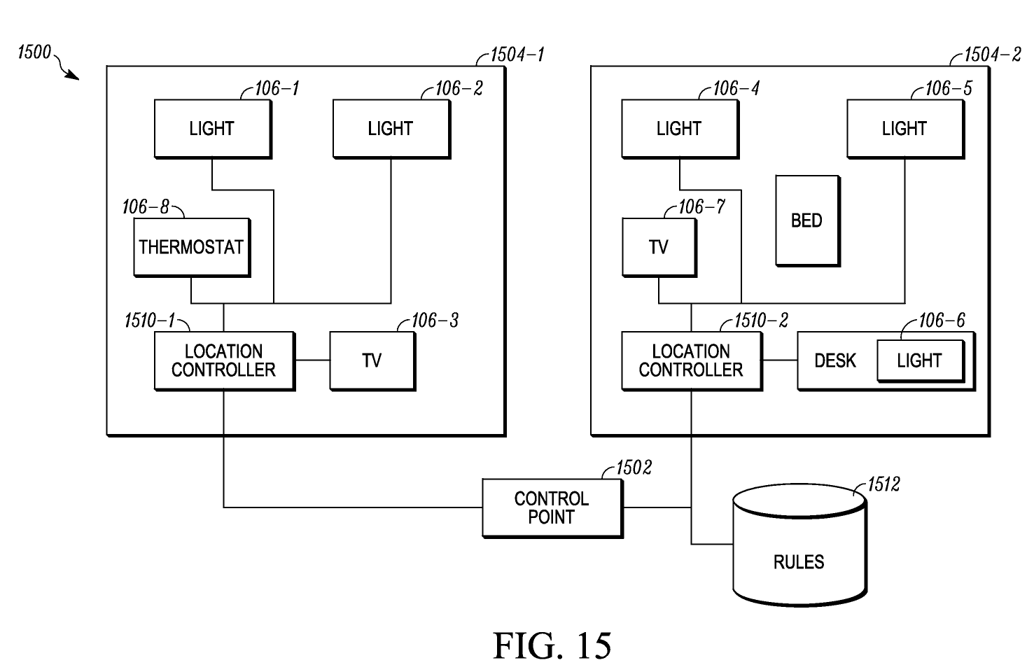

FIG. 15 depicts a simplified system 1500 according to one embodiment. As shown, controller 1502, locations 1504, and rules storage 1506 are provided. Locations 1504 also include devices 106, and location controller 1510.

Controller 1502 is configured to control items 108 in locations 1504. A location may be any area, such as a room, hallway, etc. System 1500 may be broken up into locations 1504. For example, the locations may be found in a house, business, or any other area. Although specific locations 1504 are described, it will be understood that any number of locations may be controlled using controller 1502.

Controller 1502 may cause actions to be performed with devices 106. For example, devices 106 may be controlled by turning them off, turning them on, etc. Rules in rules storage 1506 may be used to determine which actions to perform automatically. In one embodiment, controller 1502 may communicate through a network to location controllers 1510. Location controllers 1510 may then cause the actions to be performed with devices 106 that are in a specific location. For example, controller 1150-1 may be able to control devices 106-1-106-7.

Devices 106 may be any items that may be physical or virtual. For example, a physical device may be an actual device that is physically located in location 1504. Devices 106 shown are physical devices, but it will be understood that virtual devices may also be controlled.

User interface 102 may be located on one of devices 106. Devices 106 can be controlled and can have an interface 102 that provides the clustering to allow control of other devices 106.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
displaying a portion of a plurality of devices in a viewing area on an interface, the portion of the plurality of devices being controllable automatically through the interface;
receiving a selection of a device in the portion of the plurality of devices;
determining, by a computing device, a first set of devices in the plurality of devices that includes a similar controllable feature as the selected device;
determining a second set of devices in the portion of the plurality of devices that does not include the similar controllable feature; and
replacing the second set of devices with the first set of devices in the viewing area, wherein the similar controllable feature for the selected device and the first set of devices is controllable through the interface.

2. The method of claim 1, wherein replacing comprises displaying the first set of devices in a set of positions previously occupied by the second set of devices in the viewing area.

3. The method of claim 2, further comprising leaving the selected device in a position in which the selected device was selected.

4. The method of claim 2, further comprising leaving a third set of devices in the portion of the plurality of devices that includes the similar controllable feature in a set of positions occupied by the third set of devices when the selected device was selected.

5. The method of claim 1, further comprising displaying a control for the similar controllable feature to allow controlling of the first set of devices and the selected device using the interface.

6. The method of claim 1, wherein determining the first set of devices is based on a type of device associated with the selected device.

7. The method of claim 1, wherein determining the first set of devices is based on a minimum set of controllable features associated with the selected device.

8. The method of claim 1, wherein determining the first set of devices comprises:
determining a first set of controllable features associated with the selected device; and
determining the first set of devices based on a similarity of a second set of controllable features associated with the first set of devices and the first set of controllable features associated with the selected device.

9. The method of claim 8, wherein determining the first set of devices comprises determining if at least a portion of the first set of controllable features matches at least a portion of the second set of controllable features.

10. The method of claim 8, wherein the first set of devices has additional controllable features not included in the first set of controllable features.

11. The method of claim 10, wherein:
controllable features that match in the first set of controllable features and the second set of controllable features are displayed on the interface to allow the first set of the devices and the selected device to be controlled together, and
the additional controllable features are not displayed in the viewing area.

12. A non-transitory computer-readable storage medium containing instructions for controlling a computer system to be operable to:
display a portion of a plurality of devices in a viewing area on an interface, the portion of the plurality of devices being controllable automatically through the interface;
receive a selection of a device in the portion of the plurality of devices;
determine a first set of devices in the plurality of devices that includes a similar controllable feature as the selected device;
determine a second set of devices in the portion of the plurality of devices that does not include the similar controllable feature; and
replace the second set of devices with the first set of devices in the viewing area, wherein the similar controllable feature for the selected device and the first set of devices is controllable through the interface.

13. The non-transitory computer-readable storage medium of claim 12, wherein replace comprises display the first set of devices in a set of positions previously occupied by the second set of devices in the viewing area.

14. The non-transitory computer-readable storage medium of claim 13, further operable to leave the selected device in a position in which the selected device was selected.

15. The non-transitory computer-readable storage medium of claim 13, further operable to leave a third set of devices in the portion of the plurality of devices that includes the similar controllable feature in a set of positions occupied by the third set of devices when the selected device was selected.

16. The non-transitory computer-readable storage medium of claim 12, further operable to display a control for the similar controllable feature to allow controlling of the first set of devices and the selected device using the interface.

17. The non-transitory computer-readable storage medium of claim 12, wherein determine the first set of devices is based on a type of device associated with the selected device.

18. The non-transitory computer-readable storage medium of claim 12, wherein determine the first set of devices is based on a minimum set of controllable features associated with the selected device.

19. The non-transitory computer-readable storage medium of claim 12, wherein determine the first set of devices comprises:
determine a first set of controllable features associated with the selected device; and
determine the first set of devices based on a similarity of a second set of controllable features associated with the first set of devices and the first set of controllable features associated with the selected device.

20. An apparatus comprising:
one or more computer processors; and
a computer-readable storage medium comprising instructions for controlling the one or more computer processors to be operable to:
display a portion of a plurality of devices in a viewing area on an interface, the portion of the plurality of devices being controllable automatically through the interface;
receive a selection of a device in the portion of the plurality of devices;
determine a first set of devices in the plurality of devices that includes a similar controllable feature as the selected device;
determine a second set of devices in the portion of the plurality of devices that does not include the similar controllable feature; and
replace the second set of devices with the first set of devices in the viewing area, wherein the similar controllable feature for the selected device and the first set of devices is controllable through the interface.
